(19) United States
(12) Patent Application Publication
(10) Pub. No.: US 2021/0248152 A1
(43) Pub. Date: Aug. 12, 2021

(54) DATA PRIORITIZATION BASED ON DETERMINED TIME SENSITIVE ATTRIBUTES

(71) Applicant: INTERNATIONAL BUSINESS MACHINES CORPORATION, Armonk, NY (US)

(72) Inventors: Paul R. Bastide, Ashland, MA (US); Senthil Bakthavachalam, Yorktown Heights, NY (US); Shakil Manzoor Khan, Highland Mills, NY (US)

(21) Appl. No.: 16/788,357

(22) Filed: Feb. 12, 2020

(51) Int. Cl. G06F 16/25; G06F 16/28; G06F 40/279

(52) U.S. Cl. CPC G06F 16/254; G06F 3/0482; G06F 40/279; G06F 16/284

(57) ABSTRACT

A method for prioritizing data for processing based on a prioritization derived from responses to computer-generated surveys is provided. The method may include detecting and extracting time sensitive attributes associated with structured and unstructured data, wherein the time sensitive attributes comprise data elements. The method may further include generating a survey based on the extracted time sensitive attributes and presenting the computer-generated survey for determining a priority level for the extracted time sensitive attributes. The method may further include generating a prioritization database table and the prioritization rules to govern priority for the time sensitive attributes by aggregating feedback received in response to the computer-generated survey. The method may also include processing and prioritizing incoming data messages comprising data elements that are associated with the time sensitive attributes based on the generated prioritization database table and the prioritization rules.

### BACKGROUND

The present invention relates generally to the field of computing, and more specifically, to optimizing and prioritizing data for data processing based on feedback to computer-generated surveys.

Generally, the use of data reservoirs in data processing systems may promote continuous innovation by leveraging data and analytics to drive an organization more effectively. Specifically, data reservoirs are a service that may run analytics to support a business, support the ad hoc analysis of data, and support the generation of new analytical models. For example, a data reservoir may enable different forms of customer specific data to be stored in a uniform large storage repository for data analysis by a data processing engine, where the data reservoir is specifically used for multi-dimensional analytics to discover optimal business outcomes. Multi-Tenant data reservoirs are quickly becoming a pattern in industry, where a multi-tenant data reservoir may isolate specific tenant data from all others for data processing and analytics. For example, a multi-tenant healthcare solution may store and analyze Emergency Health Record (EHR), Protected Healthcare Information (PHI), and other medical data that may co-exist from multiple vendors, customers, and organizations.

### SUMMARY

A method for automatically prioritizing data for processing based on a prioritization derived from responses to computer-generated surveys is provided. The method may include in response to receiving structured and unstructured data, detecting and extracting time sensitive attributes associated with structured and unstructured data, wherein the time sensitive attributes comprise data elements associated with the structured and unstructured data. The method may further include generating a survey based on the extracted time sensitive attributes, and presenting the computer-generated survey for determining a priority level for the extracted time sensitive attributes. The method may further include generating a prioritization database table and prioritization rules to govern priority for the time sensitive attributes by aggregating feedback received in response to the computer-generated and presented survey. The method may also include, based on the generated prioritization database table and the prioritization rules derived from the expert feedback to the computer-generated survey, processing and prioritizing incoming data messages comprising data elements that are associated with the time sensitive attributes.

A computer system for automatically prioritizing data for processing based on a prioritization derived from responses to computer-generated surveys is provided. The computer system may include one or more processors, one or more computer-readable memories, one or more computer-readable tangible storage devices, and program instructions stored on at least one of the one or more storage devices for execution by at least one of the one or more processors via at least one of the one or more memories, whereby the computer system is capable of performing a method. The method may include in response to receiving structured and unstructured data, detecting and extracting time sensitive attributes associated with structured and unstructured data, wherein the time sensitive attributes comprise data elements associated with the structured and unstructured data. The method may further include generating a survey based on the extracted time sensitive attributes, and presenting the computer-generated survey for determining a priority level for the extracted time sensitive attributes. The method may further include generating a prioritization database table and prioritization rules to govern priority for the time sensitive attributes by aggregating feedback received in response to the computer-generated and presented survey. The method may also include based on the generated prioritization database table and the prioritization rules derived from the expert feedback to the computer-generated survey, processing and prioritizing incoming data messages comprising data elements that are associated with the time sensitive attributes.

A computer program product for automatically prioritizing data for processing based on a prioritization derived from responses to computer-generated surveys is provided. The computer program product may include one or more computer-readable storage devices and program instructions stored on at least one of the one or more tangible storage devices, the program instructions executable by a processor. The computer program product may include program instructions to, in response to receiving structured and unstructured data, detect and extract time sensitive attributes associated with structured and unstructured data, wherein the time sensitive attributes comprise data elements associated with the structured and unstructured data. The computer program product may include program instructions to generate a survey based on the extracted time sensitive attributes, and present the computer-generated survey for determining a priority level for the extracted time sensitive attributes. The computer program product may include program instructions to generate a prioritization database table and prioritization rules to govern priority for the time sensitive attributes by aggregating feedback received in response to the computer-generated and presented survey. The computer program product may include program instructions to, based on the generated prioritization database table and the prioritization rules derived from the expert feedback to the computer-generated survey, process and prioritize incoming data messages comprising data elements that are associated with the prioritized time sensitive attributes.

### BRIEF DESCRIPTION OF THE SEVERAL VIEWS OF THE DRAWINGS

These and other objects, features and advantages of the present invention will become apparent from the following detailed description of illustrative embodiments thereof, which is to be read in connection with the accompanying drawings. The various features of the drawings are not to scale as the illustrations are for clarity in facilitating one skilled in the art in understanding the invention in conjunction with the detailed description. In the drawings:

FIG. 1 illustrates a networked computer environment according to one embodiment;

FIG. 2 is an example of structured and unstructured data according to one embodiment;

FIG. 3 is an operational flowchart illustrating the steps carried out by a program for automatically prioritizing data for processing based on prioritization rules derived from responses to computer-generated surveys according to one embodiment;

FIG. 4 is an exemplary diagram of a program for processing and prioritizing incoming data messages based on prioritization rules associated with time sensitive attributes;

FIG. 5 is a block diagram of the system architecture of the program for automatically prioritizing data for processing based on prioritization rules derived from responses to computer-generated surveys according to one embodiment;

FIG. 6 is a block diagram of an illustrative cloud computing environment including the computer system depicted in FIG. 1, in accordance with an embodiment of the present disclosure; and

FIG. 7 is a block diagram of functional layers of the illustrative cloud computing environment of FIG. 6, in accordance with an embodiment of the present disclosure.

### DETAILED DESCRIPTION

Detailed embodiments of the claimed structures and methods are disclosed herein; however, it can be understood that the disclosed embodiments are merely illustrative of the claimed structures and methods that may be embodied in various forms. This invention may, however, be embodied in many different forms and should not be construed as limited to the exemplary embodiments set forth herein. In the description, details of well-known features and techniques may be omitted to avoid unnecessarily obscuring the presented embodiments.

Embodiments of the present invention relate generally to the field of computing, and more particularly, to prioritizing and optimizing the processing of data based on time sensitive attributes extracted from the data. The following described exemplary embodiments provide a system, method and program product for automatically prioritizing data elements for data processing based on prioritization rules derived from computer-generated surveys and responses to the computer-generated surveys from one or more experts. Specifically, the present embodiment has the capacity to improve the technical field associated with data processing by using a prioritization list and prioritization rules associated with time sensitive attributes extracted from data to optimize and prioritize the processing of incoming data messages containing the time sensitive attributes. More specifically, the system, method and program product may extract time sensitive attributes from structured and unstructured data and prioritize the time sensitive attributes for processing by presenting the time sensitive attributes in a computer-generated survey to one or more experts for review and aggregating responses from the experts to generate the prioritized list and the prioritized rules for the time sensitive attributes.

As previously described with respect to data processing, multi-tenant data reservoirs are quickly becoming a pattern in industry, where a data reservoir may isolate specific tenant data from all others for data processing and analytics. For example, multi-tenant healthcare solution may store Emergency Health Records (EHRs), Protected Healthcare Information (PHI), and other medical data from multiple vendors. In such a platform, data may be collected from multiple tenants, which may include a combination of different healthcare providers and hospitals, and then the data may be added to the data reservoir for real-time analysis using an ETL (Extraction-Transformation-Load) process that may put the data in a common format and load the data into the data reservoir. For example, a specific tenant may enter/upload a data record and/or data report that may include one or more data elements which may be formatted as a data message for ETL processing. Thereafter, a pipeline of activities may be executed to complete the ETL processing so that the data element may be uploaded and analyzed by the data reservoir. Each message may require a significant amount of time to complete the ETL process, and as new data messages are queued for processing, the system may generally process the data sequentially without regard for prioritization based on the importance of certain data elements. As a typical solution, the system may spread the processing load across multiple processing systems which may execute the ETL, however, spreading the processing load across multiple processing systems still does not prioritize the processing of certain data elements over other data elements due to the importance of the certain data elements.

As an example, a tenant such as a hospital may admit a first patient and a second patient to the hospital. A doctor may diagnose the first patient as having a stubbed toe and may record the diagnosis along with other information about the first patient on the tenant's computer system that is associated with the hospital. Another doctor may diagnose the second patient as having torn ligaments in the second patient's leg with deep cuts on the leg caused by a car accident, and the doctor may record that diagnosis along with other information associated with the second patient in the tenant's computer system. The diagnosis information associated with both patients may uploaded for ETL processing around the same time so that the diagnosis data may be analyzed by a data reservoir. The tenant's computer system may use one or multiple processing systems, however, for real-time analysis purposes, the information associated with the second patient may be more important to process and analyze before the information associated with the first patient due to the severity of the second patient's injuries. More specifically, torn ligaments and deep cuts may be deemed more important and/or more time sensitive for analysis than a stubbed toe. Therefore, during processing, a message carrying the data element associated with the diagnosis pertaining to the second patient may need to be prioritized over the data message carrying the diagnosis information associated with the first patient.

As such, it may be advantageous, among other things, to provide a method, computer system, and computer program product for automatically prioritizing and optimizing the processing of data based on time sensitive attributes extracted from the data. Specifically, the method, computer system, and computer program product may extract time sensitive attributes from structured and unstructured data, whereby the time sensitive attributes may include data elements pertaining to the structured or unstructured data such as a section/field of the structured or unstructured data, a code associated with the structured and unstructured data, and/or a word/phrase within the structured and unstructured data. Thereafter, the method, computer system, and computer program product may prioritize the time sensitive attributes for processing by presenting the time sensitive attributes in a computer-generated survey to one or more experts for review and aggregating responses from the experts to generate a prioritized list and prioritized rules for the time sensitive attributes. Then, the method, computer system, and computer program product may use the prioritized list and the prioritization rules associated with the time sensitive attributes to optimize and prioritize the processing of incoming data messages containing the time sensitive attributes.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

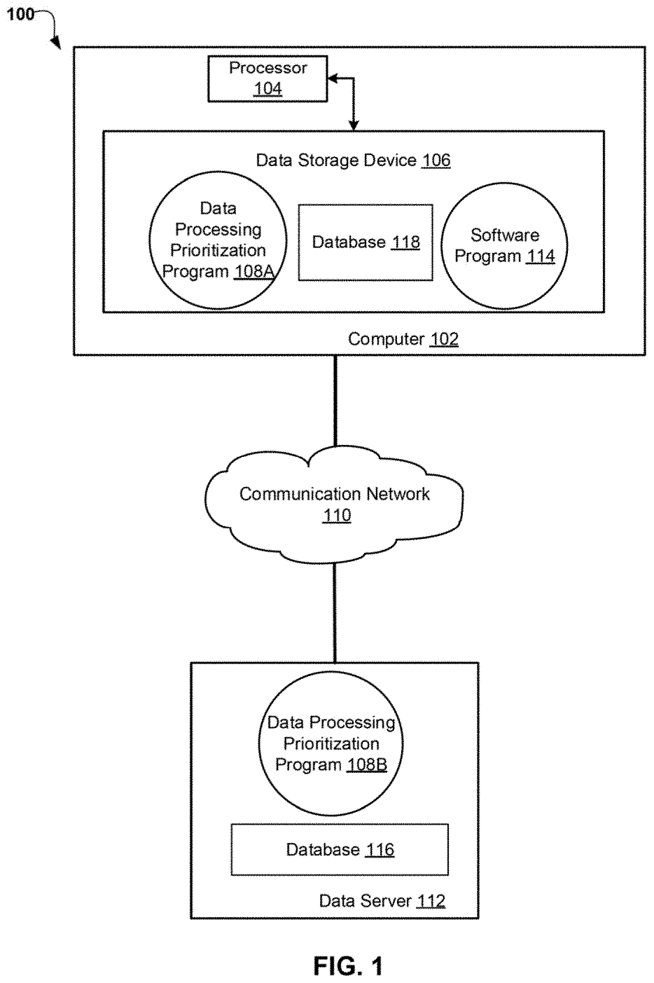

Referring now to FIG. 1, an exemplary networked computer environment 100 in accordance with one embodiment is depicted. The networked computer environment 100 may be a computing environment that is associated with a tenant, such as a healthcare provider and/or a hospital, in a multi-tenant environment. The networked computer environment 100 may include a computer 102 with a processor 104 and a data storage device 106 that is enabled to run a software program 114 and a data processing prioritization program 108A and may include a database 118. The client computer 102 may be one of many client computers associated with the tenant and the tenant's computing system, which may further be associated with a multi-tenant computing environment that includes client computers and computing systems from multiple tenants. The software program 114 may be an application program such as a data processing program (for example, Apache Kafka or Apache Hadoop) and/or one or more apps and programs running on the client computer 102. The data processing prioritization program 108A may communicate with the software program 114 and the database 118, whereby the database may be, for example, an Apache HBase database, a structured query language (SQL) database, and/or one or more relational databases. The networked computer environment 100 may also include a server 112 that is enabled to run a data processing prioritization program 108B and the communication network 110. The server 112 may, for example, be a data reservoir that may further be associated with a multi-tenant environment. The networked computer environment 100 may include a plurality of computers 102 and servers 112, only one of which is shown for illustrative brevity. For example, the plurality of computers 102 may include a plurality of interconnected devices, such as a desktop computer, internet of things (IoT) computing device, and a mobile computing device (phone, tablet, and laptop).

According to at least one implementation, the present embodiment may also include a database 116, which may be running on server 112. The communication network 110 may include various types of communication networks, such as a wide area network (WAN), local area network (LAN), a telecommunication network, a wireless network, a public switched network and/or a satellite network. It may be appreciated that FIG. 1 provides only an illustration of one implementation and does not imply any limitations with regard to the environments in which different embodiments may be implemented. Many modifications to the depicted environments may be made based on design and implementation requirements.

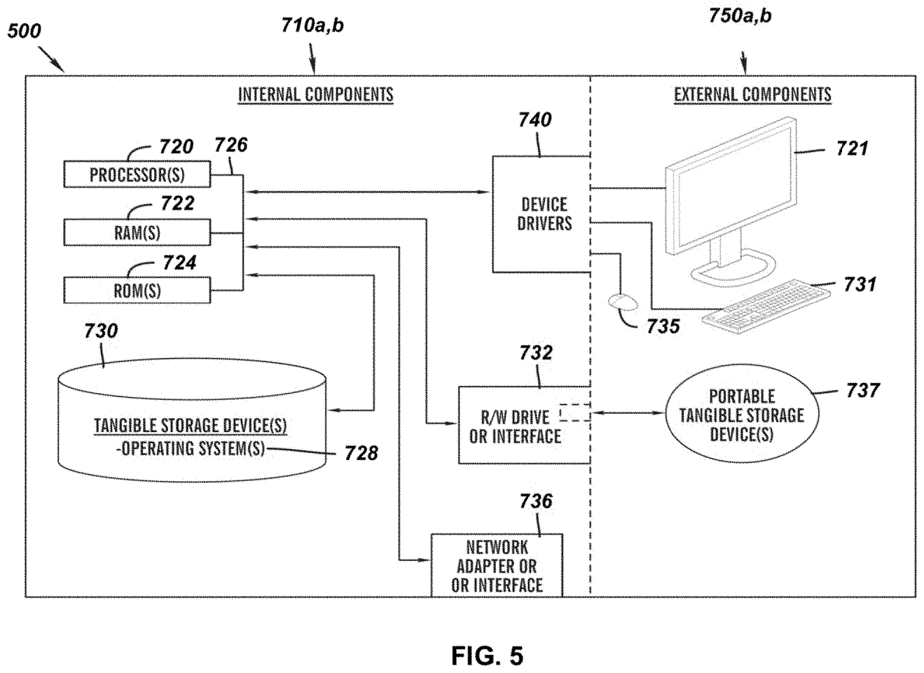

The client computer 102 may communicate with server computer 112 via the communications network 110. The communications network 110 may include connections, such as wire, wireless communication links, or fiber optic cables. As will be discussed with reference to FIG. 5, server computer 112 may include internal components 800a and external components 900a, respectively, and client computer 102 may include internal components 800b and external components 900b, respectively. Server computer 112 may also operate in a cloud computing service model, such as Software as a Service (SaaS), Platform as a Service (PaaS), or Infrastructure as a Service (IaaS). Server 112 may also be located in a cloud computing deployment model, such as a private cloud, community cloud, public cloud, or hybrid cloud. Client computer 102 may be, for example, a mobile device, a telephone, a personal digital assistant, a netbook, a laptop computer, a tablet computer, a desktop computer, or any type of computing device capable of running a program and accessing a network. According to various implementations of the present embodiment, the notification data protection program 108A, 108B may interact with a database 116 that may be embedded in various storage devices, such as, but not limited to, a mobile device 102, a networked server 112, or a cloud storage service.

According to the present embodiment, a program, such as a data processing prioritization program 108A and 108B may run on the client computer 102 and/or on the server computer 112 via a communications network 110. The data processing prioritization program 108A, 108B may automatically prioritize and optimize the processing of data based on time sensitive attributes extracted from the data which may be received on the client computer 102. Specifically, for example, client computer 102 may run a data processing prioritization program 108A, 108B, that may interact with a database 116 and a software program 114, whereby the data processing prioritization program 108A, 108B may receive structured and/or unstructured data. Then, the data processing prioritization program 108A, 108B may identify and extract time sensitive attributes associated with the structured and unstructured data. Thereafter, the data processing prioritization program 108A, 108B may generate prioritization rules for the time sensitive attributes by presenting the time sensitive attributes in a computer-generated survey for review by experts in a corresponding field, determining weights/values for the time sensitive attributes based on expert feedback, and generating a prioritized list of the time sensitive attributes by aggregating the weighted expert feedback. Then, the method, computer system, and computer program product may use the prioritized list of time sensitive attributes to optimize and prioritize incoming data messages containing the time sensitive attributes.

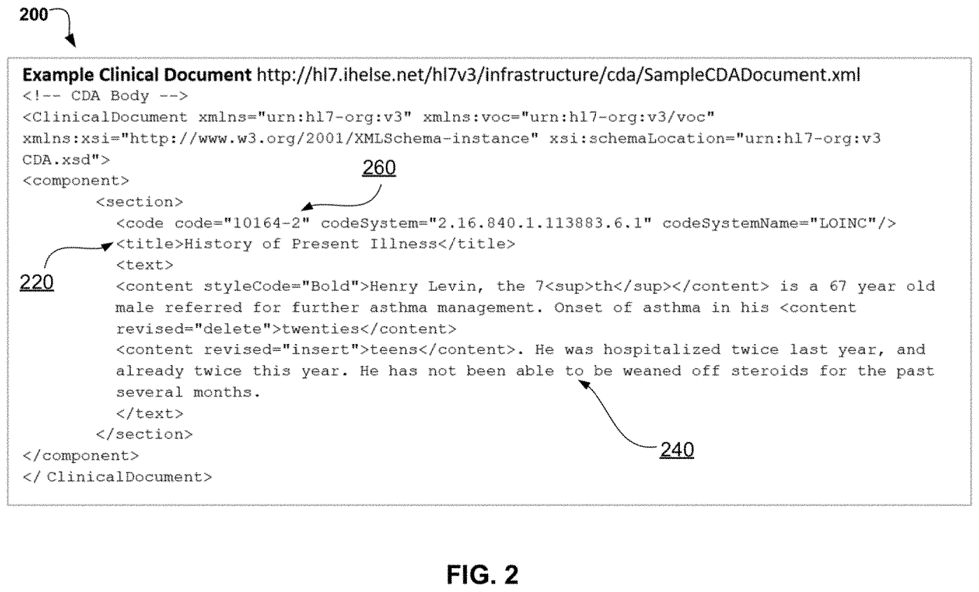

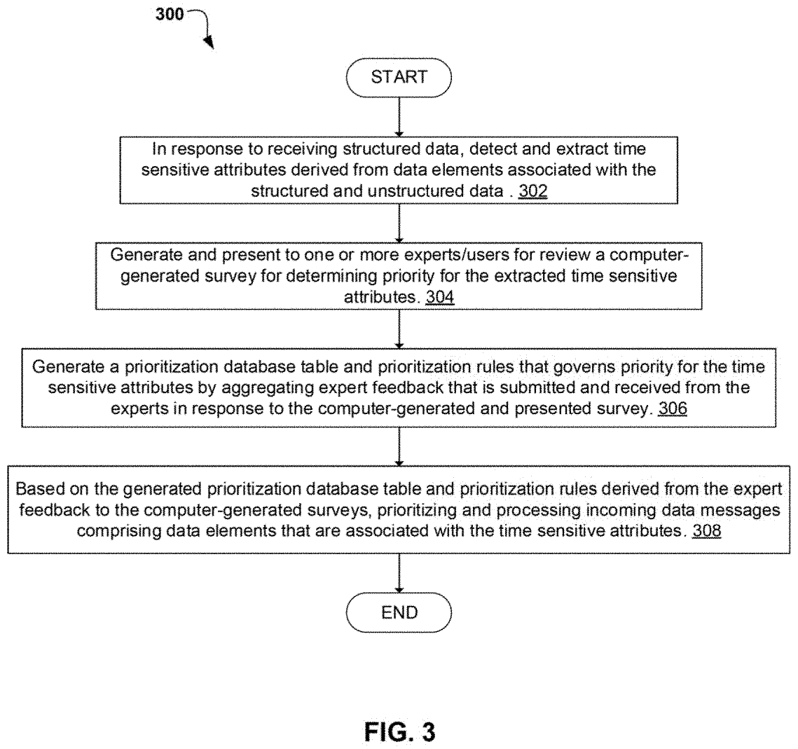

Referring now to FIG. 2, an example of structured/unstructured data 200 that may be received by the data processing prioritization program 108A, 108B is depicted. As previously described, the data processing prioritization program 108A, 108B may receive structured and unstructured data for data processing and analysis by a data reservoir. Structured data may refer to data that resides in a fixed format and may include data contained in database tables, relational databases, and spreadsheets (such as health records). Unstructured data, on the other hand, may include data that may not be so readily classified or fixed, and may include photos and graphic images, videos, streaming instrument data, webpages, PDF files, PowerPoint presentations, emails, blog entries, wikis and word processing documents. In the medical field, for example, a clinical document 200 is depicted in FIG. 2. The clinical document may be based on a clinical document architecture (CDA), which is an XML-based electronic standard used for clinical document exchange. CDA may be a flexible standard, in that due to its use of XML language, it allows language to be broken into structured parts for electronic processing. As depicted in FIG. 2, the clinical document may include different parts that identify information such as a title 220 for the document 200, text 240 within the document 200, and a code 260 associated with the document 200. For example, and as depicted in FIG. 2, the data processing prioritization program 108A, 108B may identify a type of the clinical document (or type of information contained within the document) based on a code 260, whereby the code 260 may further be based on a database comprising logical observation identifiers names and codes (LOINC). More specifically, LOINC is a database that applies universal code names and identifiers to medical terminology related to electronic health records with the purpose of assisting in the electronic exchange and gathering of clinical results. Thus, the data processing prioritization program 108A, 108B may identify the sections of the clinical document (i.e. the code 260, the title 220, and the text 240), and as will be described with reference to FIG. 3, the data processing prioritization program 108A, 108B may further use natural language processing (NLP) techniques to identify and classify the specific words and phrases associated with the different sections. The data processing prioritization program 108A, 108B may also receive structured and unstructured data of other formats such as Avro, comma-separated value (CSV), protocol buffers (Protobuf), and JavaScript Object Notation (JSON).

Referring now to FIG. 3, an operational flowchart 300 illustrating the steps carried out by a program for automatically optimizing and prioritizing the processing of data based on prioritization rules derived from computer-generated surveys according to one embodiment is depicted. Specifically, beginning at step 202, the data processing prioritization program 108A, 108B may, in response to receiving structured and unstructured data, detect and extract time sensitive attributes associated with the structured and unstructured data by scanning the structured and unstructured data for data elements contained within the structured and unstructured data. As previously described, the received structured data may include data entries associated with database tables, relational databases, and spreadsheets (such as data entries that include health and hospital records). Furthermore, the unstructured data may include data reports, photos and graphic images, PDF files, emails, and word processing documents (such as doctor's notes and patient evaluations found in a report). In turn, the data processing prioritization program 108A, 108B may extract the time sensitive attributes from the structured and unstructured data, whereby the time sensitive attributes may include data elements and text pertaining to the structured and unstructured data such as a section/field of the structured or unstructured data, a code associated with the structured and unstructured data, and/or a word/phrase within the structured and unstructured data. According to one embodiment, the data processing prioritization program 108A, 108B may detect and extract time sensitive attributes associated with the structured and unstructured data by using natural language processing techniques, such as a natural language toolkit (NLTK). For example, the data processing prioritization program 108A, 108B may use the NLTK, which may include a suite of text processing libraries for classification, tokenization, normalizing, stemming, tagging, parsing, and semantic reasoning, to categorize the sections, text, numbers, and codes associated with the structured and unstructured data. More specifically, in response to receiving a clinical report, one or more data entries in a data record, and/or one or more machines attached to or associated with a patient, the data processing prioritization program 108A, 108B may use the NLTK to detect time sensitive attributes (or data elements/text) associated with the patient, whereby the time sensitive attributes may be identified and categorized according to “First Name,” “Last Name,” “Diagnosis”, “Blood Pressure,” “Social Security,” “Phone,” “State,” and “Town”). Furthermore, for example, and based on the clinical document described in FIG. 1, the data processing prioritization program 108A, 108B may use the NLTK to determine that “Henry” is a First Name, “Levin” is a Last Name, and “asthma” is a Diagnosis. As will be described, the data processing prioritization program 108A, 108B may use the time sensitive attributes to determine how to optimize and prioritize the processing of data in, for example, an ETL data processing procedure.

Next, at 304, based on the detected and extracted time sensitive attributes, the data processing prioritization program 108A, 108B may generate and present to one or more experts/users for review a computer-generated survey for determining priority for the extracted time sensitive attributes. As previously described, the data processing prioritization program 108A, 108B may prioritize the processing of data elements associated with the received structured and unstructured data based on the time sensitive attributes. More specifically, the data processing prioritization program 108A, 108B may prioritize the processing of certain data by prioritizing a time sensitive attribute associated with a data element over the processing of another time sensitive attribute associated with another data element. In order to determine which time sensitive attribute, or data element, is more important to process (i.e. which time sensitive attribute should be processed more quickly, or before, another time sensitive attribute), the data processing prioritization program 108A, 108B may generate a survey and rely on expert responses to the computer-generated survey to generate and/or update a prioritization list and prioritization rules for processing the data elements associated with the time sensitive attributes. Specifically, according to one embodiment, the data processing prioritization program 108A, 108B may generate a survey for prioritizing the time sensitive attributes by first selecting a subset of the time sensitive attributes that were detected and extracted at step 302. For example, and as previously described, a set of time sensitive attributes such as “First Name,” “Last Name,” “Diagnosis”, “Blood Pressure,” “Prescription,” “Social Security,” “Phone,” “State,” and “Town,” may be identified at step 302. Thereafter, the data processing prioritization program 108A, 108B may select different subsets of the time sensitive attributes, whereby the different subsets may include different combinations of the time sensitive attributes for the purpose of determining a priority level for each of the time sensitive attributes. For example, the data processing prioritization program 108A, 108B may select the following different subsets or combinations (C1, C2 . . . Cn) of time sensitive attributes: where C1 includes the time sensitive attribute combination “First Name”, “Last Name”, “Blood Pressure;” where C2 includes the time sensitive attribute combination “Asthma”, “Stubbed Toe”, “Social Security;” and where C3 includes the time sensitive attribute combination “Phone” and “Last Name.” Thereafter, the data processing prioritization program 108A, 108B may generate a survey using the different combinations to ascertain which time sensitive attributes should be prioritized over other time sensitive attributes. According to one embodiment, the data processing prioritization program 108A, 108B may generate a survey, whereby the survey may be an interface including a multiple-choice questionnaire for selection by an expert/user such as the following:

C1. Which one is more important to consider for time sensitive processing?
A. First Name
B. Last Name
C. Blood Pressure

C2. Which one is more important to consider for time sensitive processing?
A. Asthma (Diagnosis 1)
B. Stubbed Toe (Diagnosis 2)
C. Social Security

C3. How would you prioritize the following two elements?
A. Phone
B. Last Name

According to one embodiment, the computer-generated survey may place the time sensitive attributes into preconfigured questions, such as a template that incorporates questions such as, “Which one is more important to consider for time sensitive processing” and/or “How would you prioritize the following two elements”.

Thus, according to one embodiment, the data processing prioritization program 108A, 108B may generate and present the survey using the different combinations which may be listed as multiple-choice options and accompanied with a question. In turn, the data processing prioritization program 108A, 108B may enable a user to select an option for each question and may also provide a “Submit” button at the end of each survey, whereby the data processing prioritization program 108A, 108B may record and store the answers submitted by the experts (for example, by storing the submitted answers on database 116, 118 in FIG. 1). Specifically, and as depicted above, the data processing prioritization program 108A, 108B may compare different types of time sensitive attributes, such as comparing the different types of fields in a report or data record, i.e. “First Name”, “Last Name”, “Blood Pressure.” Furthermore, the data processing prioritization program 108A, 108B may compare specific types of information in the different fields. For example, as depicted in C2, for the field of “Diagnosis,” the data processing prioritization program 108A, 108B may have identified different types of diagnoses pertaining to different patients, such as “Asthma” and “Stubbed Toe.” Thus, as depicted in C2 above, the data processing prioritization program 108A, 108B may compare such specific information, as well as the overall field of “Social Security,” to determine which is more important to consider for time sensitive processing. Also, according to one embodiment, the data processing prioritization program 108A, 108B may present a user with a user interface to enable a user to determine the amount of questions to incorporate in each survey and/or to determine the amount of time sensitive attributes to compare in each question (for example, enabling the user to specify to use 3 time sensitive attributes for each question).

The data processing prioritization program 108A, 108B may then present the computer-generated survey to one or more determined experts and/or users that are privy to the particular field and/or to the particular information associated with the time sensitive attributes. For example, for a tenant such as a hospital, the data processing prioritization program 108A, 108B may determine that doctors within the hospital, and/or doctors within a specified location of the hospital (i.e. same zip code, city, town, state, county, within a certain amount of miles, etc.), may qualify as experts for the particular field and/or for the particular information associated with patients and patient records. As such, according to one embodiment, the data processing prioritization program 108A, 108B may identify professional credentials/skills associated with experts/users based on, for example, local user/employee records and internal user/employee profiles by scanning the tenant hospital's computing system. Furthermore, for example, the data processing prioritization program 108A, 108B may also identify experts associated with the tenant as well as outside of the tenant based on information extracted from social media profiles such as LinkedIn® (LinkedIn and all LinkedIn-based trademarks and logos are trademarks or registered trademarks of LinkedIn Corporation and/or its affiliates), Facebook® (Facebook and all Facebook-based trademarks and logos are trademarks or registered trademarks of Facebook, Inc. and/or its affiliates), and Google® (Google and all IBM-based trademarks and logos are trademarks or registered trademarks of Google, Inc. and/or its affiliates). Thereafter, the data processing prioritization program 108A, 108B may present the computer-generated survey to the one or more identified experts and the experts may, in return, be enabled to choose a time sensitive attribute for each question and submit their answers to the computer-generated survey questions.

Furthermore, according to one embodiment, the data processing prioritization program 108A, 108B may present a user with a user interface to enable a user to schedule the generation and presentation of surveys such as daily, weekly, monthly, and/or in response to detecting that extracted time sensitive attributes (i.e. data elements) do not match time sensitive attributes stored on a prioritization database table. As such, the data processing prioritization program 108A, 108B may continuously generate surveys for time sensitive attributes that may be already evaluated and stored on a prioritization database table as well as for newly extracted time sensitive attributes to continually update and optimize the priority levels for the time sensitive attributes on the prioritization database table.

Next, at 306, the data processing prioritization program 108A, 108B may generate (and/or update) a prioritization database table and prioritization rules to govern priority for the time sensitive attributes by aggregating expert feedback submitted and received from the experts in response to the computer-generated and presented survey. As previously described, the data processing prioritization program 108A, 108B may enable a user to select an option for each question presented in the survey and may also provide a “Submit” button at the end of each survey, whereby the data processing prioritization program 108A, 108B may record and store the answers submitted by the experts. Thereafter, the data processing prioritization program 108A, 108B may retrieve the stored responses submitted by the experts and may aggregate the responses from each of the questions to assign weights/values to the time sensitive attribute. The data processing prioritization program 108A, 108B may use one or more data aggregation algorithms to aggregate the responses to the questions such as by using distributed computation functions like Count( ), Sum( ), and Average( ). Furthermore, based on the aggregated responses, the data processing prioritization program 108A, 108B may determine the time sensitive attributes that are selected the most for each of the different combinations of time sensitive attributes, whereby the most selected time sensitive attributes may be identified based on a threshold number and/or percentage such as equal to or greater than 50%. For example, for the presented survey question C2 above, the data processing prioritization program 108A, 108B may aggregate the responses to C2 using the distributed computation functions and determine that 90% of the experts selected “Asthma” as more important to consider for time sensitive processing over “Stubbed Toe” and “Social Security.”

Thereafter, based on the aggregated expert feedback, the data processing prioritization program 108A, 108B may generate (and/or update) a prioritization database table, and/or prioritization rules, to govern priority for the time sensitive attributes. Specifically, for example, based on the aggregated expert feedback, the data processing prioritization program 108A, 108B may generate a prioritization database table that may provide an ordered list of the time sensitive attributes according to priority, whereby the time sensitive attributes may be assigned weights/values in the prioritization database table to indicate a priority level for the time sensitive attributes. Furthermore, according to one embodiment, the data processing prioritization program 108A, 108B may generate one or more relational database tables for each of the listed time sensitive attributes based on the questions provided in the computer-generated surveys, whereby the one or more relational database tables may include the aggregated responses to a specific question from the computer-generated survey to indicate the rules governing priority. For example, according to one embodiment of a relational database table, a number ‘0’ may be assigned to the time sensitive attribute that is weighted/voted lower and the number ‘50’ may be assigned to the time sensitive attribute that is weighted/voted higher. Specifically, for example, the data processing prioritization program 108A, 108B may list the time sensitive attributes from question/combination C2 on the prioritization database table along with other extracted time sensitive attributes. Furthermore, based on the specific question C2 presented in the computer-generated survey, the data processing prioritization program 108A, 108B may create a relational database table for the time sensitive attribute, “Asthma,”, whereby “Asthma” is assigned a higher weight/value in the relational database table when compared to “Stubbed Toe” and “Social Security” which may be assigned a lower weight/value based on the aggregated responses to C2. Thus, the relational database table may be a representation of a prioritization rule for “Asthma” when compared to a diagnosis such as “Stubbed Toe” and when compared to a section or field of a data record such as “Social Security.” The data processing prioritization program 108A, 108B may also assign to the diagnosis, “Asthma,” a value in the prioritization database table based on the aggregated responses and combination of different questions in the computer-generated survey to reflect the overall priority level of the time sensitive attribute in the list of extracted time sensitive attributes.

Also, and as previously described, the data processing prioritization program 108A, 108B may present a user with a user interface to enable a user to schedule the generation and presentation of surveys such as daily, weekly, monthly, and/or in response to detecting that extracted time sensitive attributes (i.e. data elements) do not match time sensitive attributes stored on a prioritization database table. Furthermore, the data processing prioritization program 108A, 108B may enable a user to select which time sensitive attributes to use in the generated surveys. For example, the data processing prioritization program 108A, 108B may present the user interface and enable the user to select an option to generate surveys that incorporate the time sensitive attributes stored on the prioritization database table, that incorporates the newly extracted time sensitive attributes, and/or that incorporates a combination of both the stored time sensitive attributes and the newly extracted time sensitive attributes. As such, the data processing prioritization program 108A, 108B may continue to generate surveys for time sensitive attributes that may be already evaluated and stored on the prioritization database table as well as generate surveys for newly extracted time sensitive attributes to continually update and optimize the priority levels for the time sensitive attributes on the prioritization database table.

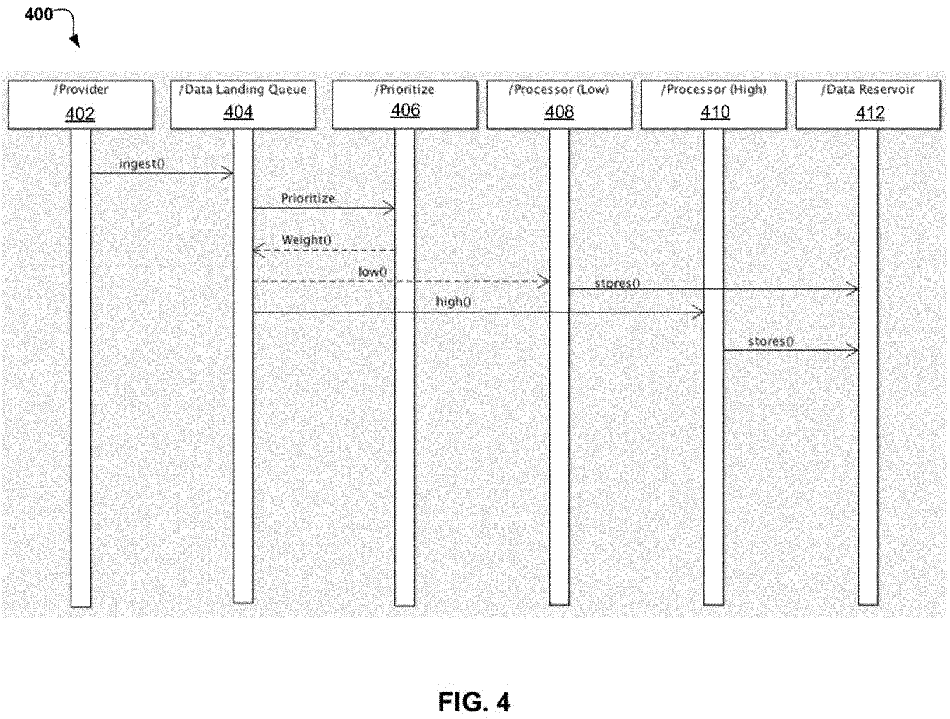

Next, at 308, based on the generated (and/or updated) prioritization database table and prioritization rules derived from the expert feedback to the computer-generated surveys, the data processing prioritization program 108A, 108B may process and prioritize incoming data messages comprising data elements that are associated with the time sensitive attributes. The following step may be described with reference to FIG. 4, whereby FIG. 4 depicts an exemplary diagram illustrating the steps for processing and prioritizing incoming data messages based on prioritization rules associated with the time sensitive attributes. Specifically, and as previously described, for example, a specific tenant such as a healthcare provider 402 may enter/upload structured and unstructured data, such as a data record and/or data report, that may include one or more data elements that may be formatted as a data message for ETL processing. The incoming data messages may be received by a data landing queue 404. In turn, the data processing prioritization program 108A, 108B may scan the data messages associated with the structured and unstructured data for data elements that may include time sensitive attributes stored on the prioritization database table.

Specifically, and based on a previously described example, a doctor may diagnose a first patient as having a stubbed toe and may record the diagnosis along with other information about the first patient in a clinical document uploaded to the tenant's computer system that is associated with the hospital. A second doctor may diagnose a second patient as having asthma, and the doctor may also record that diagnosis along with other information associated with the second patient in a data record associated with the tenant's computer system. The diagnosis information associated with the first patient may be extracted and packaged into a first data message and the diagnosis information associated with the second patient may be extracted and packaged into a second data message, and the first data message and the second message may be uploaded for ETL processing around the same time so that the diagnosis data may be analyzed by a data reservoir. As such, in response to receiving the data messages at the data landing queue 402, the data processing prioritization program 108A, 108B may scan the data messages for data elements that may include time sensitive attributes stored on the prioritization database table.

For example, the data processing prioritization program 108A, 108B may detect that the first data message includes a diagnosis and that the diagnosis is a “stubbed toe.” Furthermore, the data processing prioritization program 108A, 108B may detect that the second data message also includes a diagnosis and that the diagnosis is “asthma.” The data processing prioritization program 108A, 108B may compare the diagnoses from the first data message and the second data message to the prioritization database table to determine whether time sensitive attributes match the data elements that include a diagnosis of a stubbed toe and a diagnosis of asthma. In response to matching the data elements from the first and second data messages to the prioritization database table, the data processing prioritization program 108A, 108B may apply prioritization rules governing the data elements using the weights assigned to the data elements in the prioritization database table. Accordingly, the data processing prioritization program 108A, 108B may determine that the diagnosis, “Stubbed Toe,” has a lower priority than the diagnosis, “Asthma,” which may have a higher priority on the list of time sensitive attributes associated with the prioritization database table. As such, and according to one embodiment, the data processing prioritization program 108A, 108B may prioritize the data messages at 406 by, for example, storing the specific prioritization information in the metadata of the first data message and the second data message, respectively. Therefore, the data processing prioritization program 108A, 108B may send the first data message to a lower priority queue 408 for processing and send the second data message to the higher priority queue 410 for processing. As a result, the data processing prioritization program 108A, 108B may upload the second data message to the data reservoir 412 for analysis before uploading the first data message.

It may be appreciated that FIGS. 1-4 provide only illustrations of one implementation and does not imply any limitations with regard to how different embodiments may be implemented. Many modifications to the depicted environments may be made based on design and implementation requirements. For example, at step 304, the data processing prioritization program 108A, 108B may instead make a determination based on comparing the extracted time sensitive attributes to the prioritization database table, whereby the data processing prioritization program 108A, 108B may determine based on the comparison to 1) prioritize the processing of one data element that includes a time sensitive attribute over the processing of another data element associated with another time sensitive attribute based on the detected and extracted time sensitive attributes, and/or 2) electronically generate the survey that includes a comparison of the extracted time sensitive attributes for review by one or more experts in order to establish prioritization rules, generate a prioritization list, and/or update a prioritization list. Specifically, and as described, the data processing prioritization program 108A, 108B may determine to prioritize the processing of certain data associated with the structured and unstructured data by first comparing the extracted time sensitive attributes to a database that may already include prioritization rules associated with the extracted time sensitive attributes and/or include a prioritization list that includes the extracted time sensitive attributes. More specifically, for example, based on expert reviews of previously generated surveys, the data processing prioritization program 108A, 108B may include a database/library of time sensitive attributes represented on the prioritization database table that is used to prioritize the processing of data. Therefore, at step 304, based on the detected and extracted time sensitive attributes, the data processing prioritization program 108A, 108B may compare the extracted time sensitive attributes to the prioritization list of stored time sensitive attributes and determine that the database includes prioritization rules for the extracted time sensitive attributes based on the extracted time sensitive attributes matching time sensitive attributes on the prioritization list. Thereafter, the data processing prioritization program 108A, 108B may move straight to step 310 and prioritize the processing of data associated with the received structured and unstructured data according to the stored prioritization rules such that certain data elements that include certain time sensitive attributes are processed more quickly.

However, in response to the data processing prioritization program 108A, 108B determining that the extracted data elements do not match the stored time sensitive attributes on the prioritization database table, the data processing prioritization program 108A, 108B may determine to generate a survey that includes the non-matching data elements in order to generate prioritization rules for the data elements. According to one embodiment, the data processing prioritization program 108A, 108B may still process the data messages including the extracted non-matching data elements, however, the data processing prioritization program 108A, 108B may not include prioritization information in the data messages. Specifically, according to one embodiment, the data processing prioritization program 108A, 108B may process non-matching data messages in between processing the low priority data messages and the high priority data messages, whereby the data processing prioritization program 108A, 108B may process the high priority data messages, then the non-matching data messages, and then the low priority data messages.

Additionally, according to one embodiment, the data processing prioritization program 108A, 108B may not automatically generate the surveys in response to determining that the extracted data elements do not match the time sensitive attributes on the prioritization database table. For example, according to one embodiment, the data processing prioritization program 108A, 108B may enable a user to schedule the generation of surveys. More specifically, for example, the data processing prioritization program 108A, 108B may present a user with a user interface to enable a user to schedule the generation of surveys such as daily, weekly, monthly, and/or in response to detecting that extracted time sensitive attributes (i.e. data elements) do not match time sensitive attributes stored on the prioritization database table. As such, the data processing prioritization program 108A, 108B may continuously generate surveys for time sensitive attributes that may be already evaluated and stored on the prioritization database table as well as for newly extracted time sensitive attributes to continually update and optimize the priority levels for the time sensitive attributes on the prioritization database table.

Furthermore, according to one embodiment, the data processing prioritization program 108A, 108B may determine the priority level of an extracted time sensitive attribute by implication, which may be based on a time sensitive attribute being located near another extracted time sensitive attribute in the structured or unstructured data. For example, and as previously described, a clinical data report regarding a patient may be received by the data processing prioritization program 108A, 108B, and the clinical data report may read, “Henry Levin suffered torn ligaments and deep cuts due to a car accident.” Through the aforementioned process, the data processing prioritization program 108A, 108B may determine that the diagnoses, torn ligaments and deep cuts, may be of high priority for data processing and analysis. The data processing prioritization program 108A, 108B may also detect that the terms “torn ligaments” and “deep cuts” are within a certain distance/proximity to the name “Henry Levin.” As such, the data processing prioritization program 108A, 108B may determine that the first and last name combination of “Henry Levin” may be of high priority by implication, i.e. due to the proximity of the name to the high priority terms “torn ligaments” and “deep cuts.” Therefore, the data processing prioritization program 108A, 108B may, for example, determine to assign the last name “Levin” high priority, the combination of “Henry Levin” high priority, and/or data elements associated with the patient “Henry Levin” high priority.

Additionally, when assigning weights/values to the time sensitive attributes to indicate priority, the data processing prioritization program 108A, 108B may also weigh the experts providing the expert feedback. For example, the data processing prioritization program 108A, 108B may generate a survey based on a combination C4 that may include the time sensitive attributes “Heart Palpitations (diagnosis),” “Chest Pain (symptom),” and “Dizziness (symptom).” The data processing prioritization program 108A, 108B may send the survey, including the combination C4, to a cardiovascular expert and one or more other doctors in other fields of medicine (as previously described, the data processing prioritization program 108A, 108B may identify experts based on information extracted from social media profiles such as LinkedIn®, Facebook®, and Google®). The recipients of the computer-generated survey may have different responses to the question of “Which one is more important to consider for time sensitive processing?” However, according to one embodiment, the data processing prioritization program 108A, 108B may detect that the combination C4 includes time sensitive attributes dealing with the heart. Furthermore, the data processing prioritization program 108A, 108B may identify the professional credentials/skills of the cardiovascular expert, and thus, determine that the response from the cardiovascular expert be given more weight to the question associated with the combination C4 because of the cardiovascular expert's familiarity with the specific field. As such, the data processing prioritization program 108A, 108B may determine to assign priority based on the response by the cardiovascular expert and/or give more weight to the response by the cardiovascular expert.

The present invention may be a system, a method, and/or a computer program product. The computer program product may include a computer readable storage medium (or media) having computer readable program instructions thereon for causing a processor to carry out aspects of the present invention. The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers, and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Java, Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

FIG. 5 is a block diagram 500 of internal and external components of computers depicted in FIG. 1 in accordance with an illustrative embodiment of the present invention. It should be appreciated that FIG. 5 provides only an illustration of one implementation and does not imply any limitations with regard to the environments in which different embodiments may be implemented. Many modifications to the depicted environments may be made based on design and implementation requirements.

Data processing system 710, 750 is representative of any electronic device capable of executing machine-readable program instructions. Data processing system 710, 750 may be representative of a smart phone, a computer system, PDA, or other electronic devices. Examples of computing systems, environments, and/or configurations that may represented by data processing system 710, 750 include, but are not limited to, personal computer systems, server computer systems, thin clients, thick clients, hand-held or laptop devices, multiprocessor systems, microprocessor-based systems, network PCs, minicomputer systems, and distributed cloud computing environments that include any of the above systems or devices.

User client computer 102 (FIG. 1), and network server 112 (FIG. 1) include respective sets of internal components 710 a, b and external components 750 a, b illustrated in FIG. 5. Each of the sets of internal components 710 a, b includes one or more processors 720, one or more computer-readable RAMs 722, and one or more computer-readable ROMs 724 on one or more buses 726, and one or more operating systems 728 and one or more computer-readable tangible storage devices 730. The one or more operating systems 728, the software program 114 (FIG. 1) and the data processing prioritization program 108A (FIG. 1) in client computer 102 (FIG. 1), and the data processing prioritization program 108B (FIG. 1) in network server computer 112 (FIG. 1) are stored on one or more of the respective computer-readable tangible storage devices 730 for execution by one or more of the respective processors 720 via one or more of the respective RAMs 722 (which typically include cache memory). In the embodiment illustrated in FIG. 5, each of the computer-readable tangible storage devices 730 is a magnetic disk storage device of an internal hard drive. Alternatively, each of the computer-readable tangible storage devices 730 is a semiconductor storage device such as ROM 724, EPROM, flash memory or any other computer-readable tangible storage device that can store a computer program and digital information.

Each set of internal components 710 a, b, also includes a R/W drive or interface 732 to read from and write to one or more portable computer-readable tangible storage devices 737 such as a CD-ROM, DVD, memory stick, magnetic tape, magnetic disk, optical disk or semiconductor storage device. A software program, such as a data processing prioritization program 108A and 108B (FIG. 1), can be stored on one or more of the respective portable computer-readable tangible storage devices 737, read via the respective R/W drive or interface 732, and loaded into the respective hard drive 730.

Each set of internal components 710 a, b also includes network adapters or interfaces 736 such as a TCP/IP adapter cards, wireless Wi-Fi interface cards, or 3G or 4G wireless interface cards or other wired or wireless communication links. The data processing prioritization program 108A (FIG. 1) and software program 114 (FIG. 1) in client computer 102 (FIG. 1), and the data processing prioritization program 108B (FIG. 1) in network server 112 (FIG. 1) can be downloaded to client computer 102 (FIG. 1) from an external computer via a network (for example, the Internet, a local area network or other, wide area network) and respective network adapters or interfaces 736. From the network adapters or interfaces 736, the data processing prioritization program 108A (FIG. 1) and software program 114 (FIG. 1) in client computer 102 (FIG. 1) and the data processing prioritization program 108B (FIG. 1) in network server computer 112 (FIG. 1) are loaded into the respective hard drive 730. The network may comprise copper wires, optical fibers, wireless transmission, routers, firewalls, switches, gateway computers, and/or edge servers.

Each of the sets of external components 750 a, b can include a computer display monitor 721, a keyboard 731, and a computer mouse 735. External components 750 a, b can also include touch screens, virtual keyboards, touch pads, pointing devices, and other human interface devices. Each of the sets of internal components 710 a, b also includes device drivers 740 to interface to computer display monitor 721, keyboard 731, and computer mouse 735. The device drivers 740, R/W drive or interface 732, and network adapter or interface 736 comprise hardware and software (stored in storage device 730 and/or ROM 724).

It is understood in advance that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g. networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.
Broad network access: capabilities are available over a network and accessed through standard mechanisms that promote use by heterogeneous thin or thick client platforms (e.g., mobile phones, laptops, and PDAs).
Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).
Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.
Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.
Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.
Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.
Community cloud: the cloud infrastructure is shared by several organizations and supports a specific community that has shared concerns (e.g., mission, security requirements, policy, and compliance considerations). It may be managed by the organizations or a third party and may exist on-premises or off-premises.
Public cloud: the cloud infrastructure is made available to the general public or a large industry group and is owned by an organization selling cloud services.
Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure comprising a network of interconnected nodes.

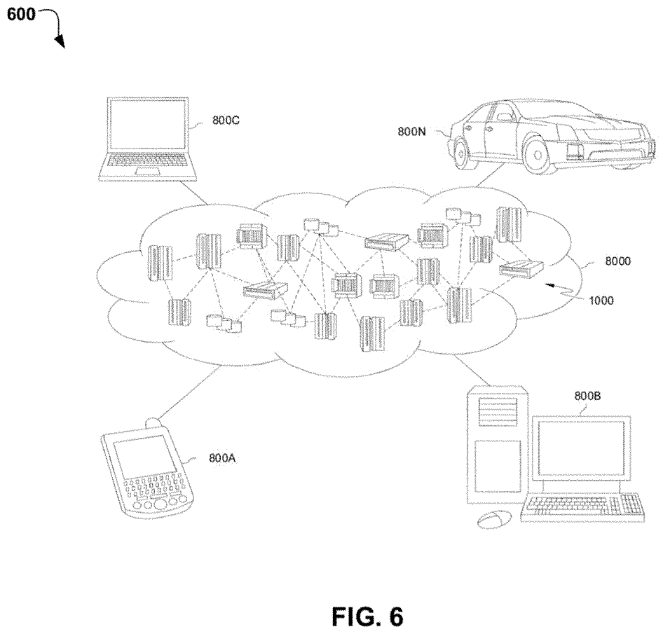

Referring now to FIG. 6, illustrative cloud computing environment 600 is depicted. As shown, cloud computing environment 600 comprises one or more cloud computing nodes 1000 with which local computing devices used by cloud consumers, such as, for example, personal digital assistant (PDA) or cellular telephone 800A, desktop computer 800B, laptop computer 800C, and/or automobile computer system 800N may communicate. Nodes 1000 may communicate with one another. They may be grouped (not shown) physically or virtually, in one or more networks, such as Private, Community, Public, or Hybrid clouds as described hereinabove, or a combination thereof. This allows cloud computing environment 8000 to offer infrastructure, platforms and/or software as services for which a cloud consumer does not need to maintain resources on a local computing device. It is understood that the types of computing devices 800A-N shown in FIG. 6 are intended to be illustrative only and that computing nodes 100 and cloud computing environment 8000 can communicate with any type of computerized device over any type of network and/or network addressable connection (e.g., using a web browser).

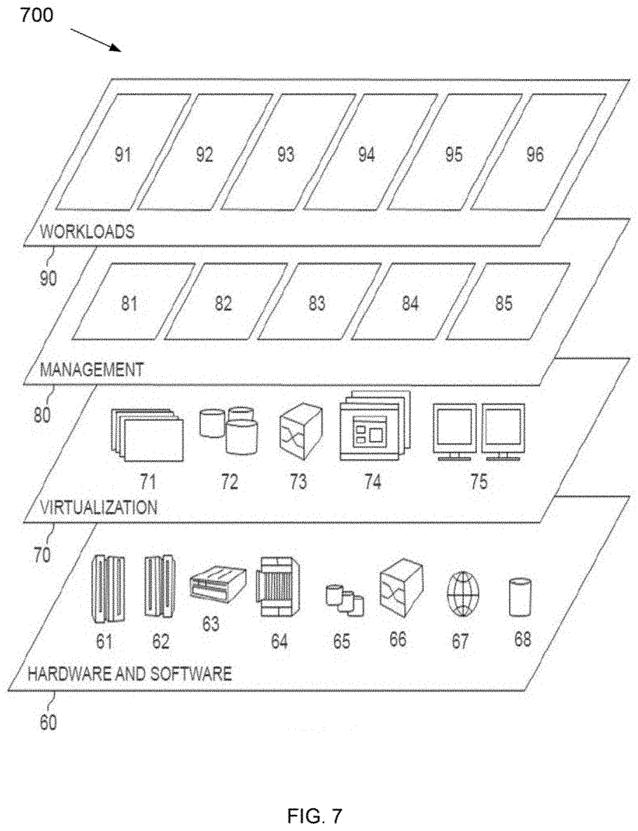

Referring now to FIG. 7, a set of functional abstraction layers 500 provided by cloud computing environment 800 (FIG. 6) is shown. It should be understood in advance that the components, layers, and functions shown in FIG. 7 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may comprise application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and data processing prioritization 96. A data processing prioritization program 108A, 108B (FIG. 1) may be offered “as a service in the cloud” (i.e., Software as a Service (SaaS)) for applications running on computing devices 102 (FIG. 1) and may automatically prioritize data for processing based on prioritization rules derived from responses to computer-generated surveys.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method for automatically prioritizing data for processing based on a prioritization derived from responses to computer-generated surveys, the method comprising:
in response to receiving structured and unstructured data, detecting and extracting, by a computer, time sensitive attributes associated with the structured and unstructured data, wherein the time sensitive attributes comprise data elements associated with the structured and unstructured data;
generating, by the computer, a survey based on the extracted time sensitive attributes, and presenting the computer-generated survey for determining a priority level for the extracted time sensitive attributes;
generating, by the computer, a prioritization database table and prioritization rules to govern priority for the time sensitive attributes by aggregating feedback received in response to the computer-generated and presented survey; and
based on the generated prioritization database table and the prioritization rules derived from the expert feedback to the computer-generated survey, processing and prioritizing, by the computer, incoming data messages comprising data elements that are associated with the prioritized time sensitive attributes.

2. The method of claim 1, wherein the time sensitive attributes comprise data elements and text pertaining to the structured and unstructured data and is selected from a group comprising a section associated with the structured and unstructured data, a code associated with the structured and unstructured data, and a word and phrase within the structured and unstructured data.

3. The method of claim 1, wherein generating and presenting the computer-generated survey further comprises:
selecting, by the computer, a subset of the extracted time sensitive attributes;
generating, by the computer, one or more different combinations of the time sensitive attributes based on the selected subset of the time sensitive attributes; and
generating, by the computer, the survey based on the one or more different combinations of time sensitive attributes, wherein the computer-generated survey comprises an interface including multiple-choice questions for each of the one or more different combinations of time sensitive attributes for selection by one or more experts.

4. The method of claim 1, wherein presenting the computer-generated survey further comprises:
determining, by the computer, one or more experts to present the computer-generated survey, wherein determining the one or more experts comprises detecting professional skills associated with one or more users of a tenant computer system, and wherein the professional skills are selected from a group comprising local user information stored on the tenant computer system and social media information; and
presenting, by the computer, the computer-generated survey to the determined one or more experts.

5. The method of claim 3, wherein aggregating the feedback received in response to the computer-generated and presented survey further comprises:
determining, by the computer, a most selected time sensitive attribute for each of the different combinations of time sensitive attributes, wherein the most selected time sensitive attribute is represented by a threshold value.

6. The method of claim 1, wherein the prioritization database table generated based on the aggregated feedback comprises an ordered list of the time sensitive attributes according to priority, whereby the time sensitive attributes may be assigned weights in the prioritization database table to indicate the priority level for the time sensitive attributes, and wherein the prioritization database table comprises one or more relational database tables representing questions from the computer-generated survey.

7. The method of claim 1, further comprising:
presenting, by the computer, a user interface comprising options to select one or more specific times to generate and present the computer-generated survey, whereby the options are selected from a group comprising generating and presenting the computer-generated survey daily, weekly, monthly, and in response to detecting that extracted time sensitive attributes do not match stored time sensitive attributes that are stored on the prioritization database table.

8. A computer system for automatically prioritizing data for processing based on a prioritization derived from responses to computer-generated surveys, comprising:
one or more processors, one or more computer-readable memories, one or more computer-readable tangible storage devices, and program instructions stored on at least one of the one or more storage devices for execution by at least one of the one or more processors via at least one of the one or more memories, wherein the computer system is capable of performing a method comprising:
in response to receiving structured and unstructured data, detecting and extracting time sensitive attributes associated with the structured and unstructured data, wherein the time sensitive attributes comprise data elements associated with the structured and unstructured data;
generating a survey based on the extracted time sensitive attributes, and presenting the computer-generated survey for determining a priority level for the extracted time sensitive attributes;
generating a prioritization database table and prioritization rules to govern priority for the time sensitive attributes by aggregating feedback received in response to the computer-generated and presented survey; and
based on the generated prioritization database table and the prioritization rules derived from the expert feedback to the computer-generated survey, processing and prioritizing incoming data messages comprising data elements that are associated with the prioritized time sensitive attributes.

9. The computer system of claim 8, wherein the time sensitive attributes comprise data elements and text pertaining to the structured and unstructured data and is selected from a group comprising a section associated with the structured and unstructured data, a code associated with the structured and unstructured data, and a word and phrase within the structured and unstructured data.

10. The computer system of claim 8, wherein generating and presenting the computer-generated survey further comprises:
selecting a subset of the extracted time sensitive attributes;
generating one or more different combinations of the time sensitive attributes based on the selected subset of the time sensitive attributes; and
generating the survey based on the one or more different combinations of time sensitive attributes, wherein the computer-generated survey comprises an interface including multiple-choice questions for each of the one or more different combinations of time sensitive attributes for selection by one or more experts.

11. The computer system of claim 8, wherein presenting the computer-generated survey further comprises:
determining one or more experts to present the computer-generated survey, wherein determining the one or more experts comprises detecting professional skills associated with one or more users of a tenant computer system, and wherein the professional skills are selected from a group comprising local user information stored on the tenant computer system and social media information; and
presenting the computer-generated survey to the determined one or more experts.

12. The computer system of claim 10, wherein aggregating the feedback received in response to the computer-generated and presented survey further comprises:
determining, by the computer, a most selected time sensitive attribute for each of the different combinations of time sensitive attributes, wherein the most selected time sensitive attribute is represented by a threshold value.

13. The computer system of claim 8, wherein the prioritization database table generated based on the aggregated feedback comprises an ordered list of the time sensitive attributes according to priority, whereby the time sensitive attributes may be assigned weights in the prioritization database table to indicate the priority level for the time sensitive attributes, and wherein the prioritization database table comprises one or more relational database tables representing questions from the computer-generated survey.

14. The computer system of claim 8, further comprising:
presenting a user interface comprising options to select one or more specific times to generate and present the computer-generated survey, whereby the options are selected from a group comprising generating and presenting the computer-generated survey daily, weekly, monthly, and in response to detecting that extracted time sensitive attributes do not match stored time sensitive attributes that are stored on the prioritization database table.

15. A computer program product for automatically prioritizing data for processing based on a prioritization derived from responses to computer-generated surveys, comprising:
one or more tangible computer-readable storage devices and program instructions stored on at least one of the one or more tangible computer-readable storage devices, the program instructions executable by a processor, the program instructions comprising:
program instructions to, in response to receiving structured and unstructured data, detect and extract time sensitive attributes associated with the structured and unstructured data, wherein the time sensitive attributes comprise data elements associated with the structured and unstructured data;
program instructions to generate a survey based on the extracted time sensitive attributes, and present the computer-generated survey for determining a priority level for the extracted time sensitive attributes;
program instructions to generate a prioritization database table and prioritization rules to govern priority for the time sensitive attributes by aggregating feedback received in response to the computer-generated and presented survey; and
program instructions to, based on the generated prioritization database table and the prioritization rules derived from the expert feedback to the computer-generated survey, process and prioritize incoming data messages comprising data elements that are associated with the prioritized time sensitive attributes.

16. The computer program product of claim 15, wherein the time sensitive attributes comprise data elements and text pertaining to the structured and unstructured data and is selected from a group comprising a section associated with the structured and unstructured data, a code associated with the structured and unstructured data, and a word and phrase within the structured and unstructured data.

17. The computer program product of claim 15, wherein the program instructions to generate and present the computer-generated survey further comprises:
program instructions to select a subset of the extracted time sensitive attributes;
program instructions to generate one or more different combinations of the time sensitive attributes based on the selected subset of the time sensitive attributes; and
program instructions to generate the survey based on the one or more different combinations of time sensitive attributes, wherein the computer-generated survey comprises an interface including multiple-choice questions for each of the one or more different combinations of time sensitive attributes for selection by one or more experts.

18. The computer program product of claim 15, wherein the program instructions to present the computer-generated survey further comprises:
program instructions to determine one or more experts to present the computer-generated survey, wherein determining the one or more experts comprises detecting professional skills associated with one or more users of a tenant computer system, and wherein the professional skills are selected from a group comprising local user information stored on the tenant computer system and social media information; and
program instructions to present the computer-generated survey to the determined one or more experts.

19. The computer program product of claim 15, wherein the prioritization database table generated based on the aggregated feedback comprises an ordered list of the time sensitive attributes according to priority, whereby the time sensitive attributes may be assigned weights in the prioritization database table to indicate the priority level for the time sensitive attributes, and wherein the prioritization database table comprises one or more relational database tables representing questions from the computer-generated survey.

20. The computer program product of claim 15, further comprising:
program instructions to present a user interface comprising options to select one or more specific times to generate and present the computer-generated survey, whereby the options are selected from a group comprising generating and presenting the computer-generated survey daily, weekly, monthly, and in response to detecting that extracted time sensitive attributes do not match stored time sensitive attributes that are stored on the prioritization database table.
